(19) United States
(12) Patent Application Publication
(10) Pub. No.: US 2025/0187359 A1
(43) Pub. Date: Jun. 12, 2025

(54) PROCESS FOR LASER MARKING A MEASURING CUP

(71) Applicant: The Procter & Gamble Company, Cincinnati, OH (US)

(72) Inventors: Joseph Craig LESTER, Liberty Township, OH (US); Anthony OGG, West Chester, OH (US); Brian William MULLINS, West Chester, OH (US)

(21) Appl. No.: 18/535,557

(22) Filed: Dec. 11, 2023

(51) Int. Cl. B41M 5/00

(52) U.S. Cl. CPC B41M 5/0064; B41M 5/0082

(57) ABSTRACT

A process for laser marking a measuring cup including the steps of: providing a measuring cup; and providing a lasing apparatus having a lens having an optical axis, a field of view, and a working distance; positioning the measuring cup at least partially within the field of view such that a first worked portion of the sidewall is oriented towards the lens, is spaced apart from the optical axis, and the optical axis is oblique or askew of the longitudinal axis; and lasing a dosing indicium into the sidewall.

### FIELD OF THE INVENTION

Process for laser marking a bitmap pattern into measuring cup.

### BACKGROUND OF THE INVENTION

Short-pulse laser marking of articles offers potential for marking of measuring cups. Short-pulse laser decoration is the process of applying pulsed energy from a nano, pico, and or femto short pulse laser to mark a pattern onto an article. A range of wavelengths and energies can be practical, depending on the constitutive properties of the article being marked.

To laser mark an object, an object is positioned in front of a lens though which a laser is sighted and pulses of energy are directed upon the object being marked. Pulses of laser energy can be directed through the lens by electronically and or mechanically controlled galvo sets. The lens focuses the laser energy onto the object. The object is positioned so that the optical axis of the of the lens is sited on the object within the bounds of the portion of the object to be marked. This approach to laser marking is suitable objects for which the portion to be laser marked can be conveniently positioned so that the optical axis of the lens is sighted within the bounds of the portion to be laser marked. Objects for which the portion to be laser marked is a flat exterior surface can be laser marked in a practical manner. Following historical practice, one object at a time is positioned in front of one lens.

Measuring cups typically have a curved or irregular shape and it can be desirable to provide dosing indicia at one or more locations on an interior surface of the measuring cup. Conventional approaches for laser marking objects are generally unsatisfactory for marking an interior surface of an object, let alone marking multiple locations on an interior surface.

Laser marking one object at a time with a laser limits the production rate of laser marked objects. In practice, the laser is idle during the increment of time after laser marking of an object is completed until the next object is placed in front of the lens for laser marking. Often, the time required for laser marking is short relative to the amount of time required to manipulate objects to be laser marked into and out position to be marked. An idle laser is unproductive capital and the time for a laser marked object to be moved downstream of the lens and an unmarked object to be positioned in front of the lens limits the rate of production of marked objects.

With the above limitations in mind, there is a continuing unaddressed need for a process for laser marking measuring cups that can produce dosing indicia on either the interior surface or exterior surface of the measuring cup in a productively efficient manner.

### SUMMARY OF THE INVENTION

A process for laser marking a measuring cup comprising the steps of: providing a measuring cup comprising: a bottom end, an open end opposite said bottom end, and a longitudinal axis passing through said bottom end, wherein said bottom end defines a resting plane; and a sidewall extending about said longitudinal axis from said bottom end to said open end; providing a lasing apparatus comprising a lens having an optical axis, a field of view, and a working distance; positioning said measuring cup at least partially within said field of view such that a first worked portion of said sidewall is oriented towards said lens, is spaced apart from said optical axis, and said optical axis is oblique or askew of said longitudinal axis; and lasing a dosing indicium into said sidewall.

### BRIEF DESCRIPTION OF THE DRAWINGS

FIG. 1 is a measuring cup.

FIG. 2 is a schematic view of a lasing apparatus.

FIG. 3 is a bitmapped pattern.

FIG. 4 is an arrangement of the lens and the measuring cup in which the optical axis is oblique to the longitudinal axis L.

FIG. 5 is an arrangement of the lens and the measuring cup in which the optical axis is askew of the longitudinal axis L.

FIG. 6 is an arrangement of the lens and the measuring cup in which the dosing indicium is in the interior surface.

FIG. 7 is an arrangement of the lens and measuring cup in which a second worked portion is in position to be lased.

FIG. 8 is an arrangement in which the dosing indicium is provided on the exterior surface of the measuring cup.

FIG. 9 is an arrangement in which a plurality of measuring cups can be lased by a single laser.

FIG. 10 is an arrangement in which a plurality of measuring cups can be lased by a single laser.

FIG. 11 is an arrangement in which a plurality of measuring cups are positioned such that the bottom end can be lased.

FIG. 12 is an arrangement individual lasing apparatuses of a plurality of lasing apparatuses are each uniquely associated with one unique plurality of measuring cups.

FIG. 13 is a measuring cup having an inner collar projecting from the bottom end.

FIG. 14 is an arrangement of in which the interior surfaces of a plurality of measuring cups are oriented towards a lens.

### DETAILED DESCRIPTION OF THE INVENTION

Many liquid and particulate products provide a measuring cup that the user can employ to measure the amount of product to be used for a task. For products such as dish detergents, laundry detergents, particulate laundry scent additives, fabric softeners, beverage concentrates, shampoo, hair conditioner, medicinal products, mouthwash, and the like, the measuring cup can be provided with the container. The measuring cup may be attached to the container, attached to the closure of the container, may function as the closure for the container, or be provided as a separate part of the product.

Measuring cups for household products are typically fabricated from plastic. Plastic measuring cups can be formed by injection molding, blow molding injection blow molding, casting, or other suitable process for making plastic parts.

Historically, dosing indicia on plastic measuring cups have been provided by printing the dosing indicia on the measuring cup, providing the dosing indicia on an in-mold label applied to the measuring cup, or molding the dosing indicia into the shape of the measuring cup as raised portions or depressed portions relative to surrounding or adjacent material constituting the measuring cup. Printing dosing indicia on plastic measuring cups is a slow process and printing on curved shapes can be technically challenging. Furthermore, printed dosing indicia are subject to wear and tear which may deteriorate the dosing indicia during use, especially if the measuring cup is placed into the washing machine along with the textiles or dishes being washed. In-mold labels require specialized equipment to handle the label and the finished measuring cup is relatively expensive to produce compared to measuring cups marked in another manner. Molding the marks into the shape of the measuring cup requires specially shaped molds. Making changes the dosing indicia molded into the measuring cup, as might be required when the formulation of the product is changed, requires new molds, which are expensive. Molded dosing indicia may also be challenging for the user to perceive in certain poorly lit environments.

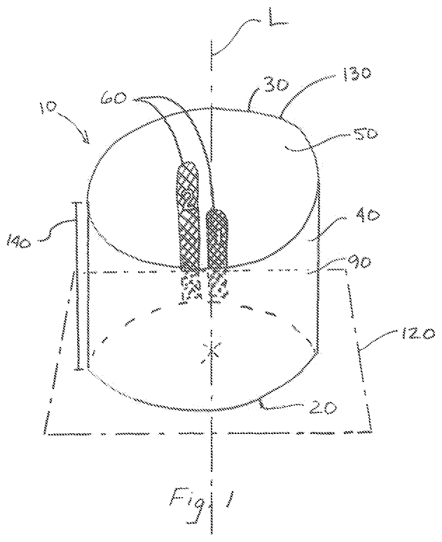

A measuring cup 10 is shown in FIG. 1. The measuring cup can comprise a bottom end 20 and an open end 30 opposite the bottom end 20. The measuring cup 10 can comprise a sidewall 40 extending from the bottom end 20 to the open end 30. The sidewall 40 can extend about the longitudinal axis L from the bottom end 20 to the open end 30. The longitudinal axis L can pass through the bottom end 20.

The sidewall 40 can have an interior surface 50. The sidewall 40 can have an exterior surface 90 opposite the interior surface 50. The measuring cup 10 can comprise a dosing indicium 60 integral with the interior surface 50. At least a portion of the dosing indicium 60 can comprise a bitmapped pattern of chemically or structurally modified bits of the sidewall 40. The bitmapped pattern can comprise at least two rows of bits. The interior surface 50 can be curved coincident with at least a portion of the dosing indicium 60.

A dosing indicium 60 is a marked portion of the sidewall 40 associated with a partial volume of the measuring cup 10 as measured orthogonal to a resting plane 120 of the measuring cup 10. The measuring cup 10 can comprise more than one dosing indicium 60. The measuring cup 10 can comprise at least two dosing indicia 60. One of the dosing indicia 60 can be positioned to indicate a first volume or quantity of liquid or particulate and another dosing indicium can be positioned to indicate a second volume or quantity of liquid or particulate that differs from the first volume or quantity of liquid or particulate. The dosing indicia 60 can be bars or measure lines. The dosing indicia 60 can be associated with a volume or quantity of liquid or particulate. For example the dosing indicia 60 can be one or more illustrations of flowers with the number of flowers constituting the dosing indicia 60 with a greater number of flowers associated with a greater scent benefit achieved by using a greater quantity of the liquid or particulate. The dosing indicia 60 can be one or more illustrations of laundry baskets associated with the quantity of liquid or particulate recommended for the volume or mass of the load of laundry.

The bottom end 20 can define a resting plane 120 of the measuring cup 10. The resting plane 120 is the plane upon which the bottom end 20, or a portion thereof or portions thereof, of the measuring cup 10 rests when the open end 30 is oriented upwardly in a position to receive a poured quantity of liquid or particulate. The bottom end 20 may be flat or substantially flat such that the entirety of the bottom end 20 rests on the resting plane 120. Optionally, the bottom end 20 may be shaped to rest upon a portion or portions of the bottom end 20 that are flat and in plane with one another such that the bottom end 20 can rest stably on a flat surface. Optionally, the bottom end 20 may rest upon 3 or more contact locations that are in plane with one another such that the bottom end 20 can rest stably on a flat surface. When the bottom end 20 is resting on a horizontal table, the resting plane 120 is coincident with the surface of the horizontal table upon which the bottom end 20 rests. Optionally, the bottom end 20 may be rounded. For example the bottom end 20 can be a dome or part of a dome. The measuring cup 10 in its entirety can be a domed shape.

The open end 30 can be defined by a peripheral rim 130. The sidewall 40 can have a sidewall height 140 between the resting plane 120 and the peripheral rim 130. The sidewall height 140 is measured orthogonal to the resting plane 120. The sidewall height 140 is a scalar quantity.

In use, the measuring cup 10 can function to contain the contents of the container within the container. When the measuring cup 10, which can be the closure of the container, is removed from the container and the open end 30 is oriented upwardly, the contents of the container can be dispensed into the measuring cup 10.

For containers in which the contents are solid objects, such as particulate laundry products and the like, the bottom end 20 need not be a closed bottom end. For example, the bottom end 20 can comprise an aperture. The aperture can provide a pathway through which the consumer can sample the aroma of the contents of the container. If the measuring cup 10 is rapidly fitted to the container the aperture can provide a pathway for gas to escape so that the pressure within the container is ambient pressure. For contents that off-gas over time, the aperture can provide for a pathway for such off-gas to escape from the container or through which the scent of the contents of the container can be sampled. The aperture can have an open area that is smaller than the cross-sectional area of individual particles that are contained in the container. The aperture can have an open area less than about 0.0001 m², optionally less than about 0.00001 m², optionally less than about 0.000001 m².

The measuring cup 10 can be fabricated from a thermoplastic material selected from the group of polyethylene terephthalate (PET), polyethylene terephthalate glycol (PETG), polystyrene (PS), polycarbonate (PC), polyvinylchloride (PVC), polyethylene naphthalate (PEN), polycyclohexylenedimethylene terephthalate (PCT), glycol-modified PCT copolymer (PCTG), copolyester of cyclohexanedimethanol and terephthalic acid (PCTA), polybutylene terephthalate (PBCT), acrylonitrile styrene (AS), styrene butadiene copolymer (SBC), or a polyolefin, for example one of low-density polyethylene (LDPE), linear low-density polyethylene (LLPDE), high-density polyethylene (HDPE), polypropylene (PP) and combinations thereof. The thermoplastic material may be a recycled thermoplastic material or combination of virgin thermoplastic material and recycled thermoplastic material. The thermoplastic material can be a bioderived material or a material formed via carbon capture. The measuring cup 10 can be a single layer of material or multiple layer of the same or different materials. The measuring cup 10 can comprise more than about 1%, optionally more than about 20%, optionally from about 1% to 100% by weight carbon from carbon capture. The measuring cup 10 can comprise pulp. Pulp can be constitutive material of the measuring cup 10 or an additive to the constitutive material of the measuring cup 10. The measuring cup 10 can be fabricated from paper or paper board or other material comprising pulp.

Pigments, colorants, and laser absorption additives may be added to the material used to construct the measure cup. Titanium dioxide and carbon black are pigments commonly used to opacify thermoplastic materials. Additional examples of laser absorption additives include: antimony tin oxide (ATO), ATO coated substrates such as mica, Sb₂O₃, indium tin oxide, tin oxides, iron oxides, zinc oxide, graphitic carbon, bismuth oxide, mixed metal oxides, metal nitrides, doped metal nitrides, metal carbides, metal borides, tungsten oxides, doped tungsten oxides, pearlescent pigments, zero valent metals such as aluminum, and mixtures thereof. An example of laser marking laser absorption additives are those commonly sold under the tradename IRIOTEC by Merck KGaA of Darmstadt Germany.

A laser, such as a pulse laser, including a short pulse laser, may be used to form the chemically or structurally modified bits of the dosing indicium 60 described herein. Suitable choice of laser wavelength in combination with pigments/colorants may suitably laser mark the surface, by chemically or structurally modifying the surface of the article. Laser absorption additives can be added to provide for more vivid and readable laser marks than can be achieved without such additives. These laser absorption additives generally absorb the laser energy specific to the wavelength followed by initiating a color change to the surrounding matrix (via local heating to cause carbonization, foaming, etc.) or the laser absorption additive itself undergoes a chemical or physical change. Examples of laser absorption additives include: titanium dioxide (TiO₂), antimony tin oxide (ATO), ATO coated substrates such as mica, Sb₂O₃, carbon black, bismuth oxide, mixed metal oxides, metal phosphates, effect pigments, zero valent metals, and mixtures thereof. An example of laser marking laser absorption additives are those commonly sold under the tradename IRIOTEC, by Merck KGaA of Darmstadt, Germany, and LASERSAFE by Eckart GmbH.

Lasers for use in the present invention are commercially available and include nano, pico, femto second lasers. These short pulse lasers can emit pulses applied at high energy-densities and high repetition rates, the high energies and high repetition rates can be important to allow laser-marking the measuring cup 10 at high speed. The laser marks themselves, which are the chemically or structurally modified bits, include marks made by oxidation, reduction, ablation, etching, foaming, carbonization, and chemical modification including bleaching to the constitutive material of the measuring cup 10.

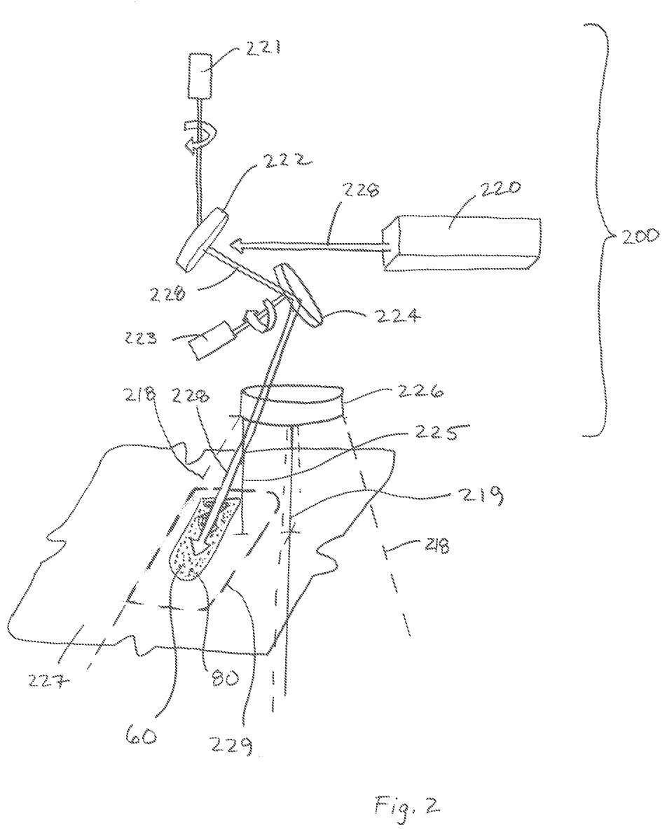

Any suitable laser can be used to mark the measuring cup 10 with chemically or structurally modified bits. An example of a lasing apparatus 200 comprising a laser 220 useful for marking a measuring cup 10 is illustrated in FIG. 2. The lasing apparatus 200 includes a laser 220 which may be any laser capable of generating sufficient energy to form chemically or structurally modified bits of the measuring cup 10, such as a UV laser, having power in the range of 1 W to 200 W, and a laser wavelength of 355 nanometers or an IR marking laser, having a power in the range of 1 W to 600 W, and a laser wavelength of 1064 nanometers. Such lasers are available from various suppliers, including an IPG ULPN-355-10-1-3-M marker or YLPN-1-1×350-50-3M MOPA module, available from IPG Photonics of Oxford, MA, United States. Other makes and types of lasers are also possible and different power ranges and settings may be used. The lasing apparatus can include optics that can be used to direct the laser beam 228, change the energy density and/or spot size of the laser beam 228, as desired. The lasing apparatus can employ a polygon scanner, such as a high throughput raster processing scanner system from Next Scan Technology. Such a scan system can employ a rotating polygon mirror for row scanning. The mirror surface can be a square that is marked in its entirety repetitively.

In the lasing apparatus 200 depicted in FIG. 2, the laser 220 projects laser beam 228 onto X-mirror 222 which is rotated by X-galvo 221. X-mirror 222 and X-galvo 221 collectively form an X-galvo set. Laser beam 228 is then projected onto Y-mirror 224 which is rotated by Y-galvo 223. Y-mirror 224 and Y-galvo 223 collectively form a Y-galvo set. The galvo sets work together to direct laser beam 228 to the desired chemically or structurally modified bit 80 to be marked on article 227. Mirrors having a low mass that can be accelerated or moved quickly by their associated galvo can be helpful.

Before laser beam 228 reaches article 227 to chemically or structurally modify the measuring cup 10 it will typically go through a lens 226. The distance from lens 226 to at least part of the worked portion 229 of the article 227 being laser marked can be approximately the working distance 225 of the lens 226 within some workable tolerance. The lens 226 can have an optical axis 219. The lens 226 can have a field of view 218. The worked portion 229 can be positioned within the field of view 218 such that the worked portion 229 is oriented towards the lens 226. The worked portion 229 can be spaced apart from the lens 226 by the working distance 225. The worked portion 229 can be spaced apart from the optical axis 219. The focal plane of the lens 226 can be flat or curved.

The combined optics of the lasing apparatus 200 may function so as to sweep the laser beam 228 across the surface of the measuring cup 10 in successive passes, marking the surface with chemically or structurally modified bits in a pattern. The laser beam 228 may sweep across the article along a first row in the grid in the X-direction, being directed by the X-mirror 222, while emitting pulses. The combination of the sweep-speed of the X-mirror 222 and the repetition rate of the laser pulses, then, determines the spacing of chemically or structurally modified bits along the X-direction. The laser 220 may emit a pulse while sweeping across the measuring cup 10 at a given location thereby resulting in a chemically or structurally modified location, or the laser 220 may omit a pulse while sweeping across the measuring cup 10 at a given location thereby resulting in an unmarked location. The laser beam 228 may be swept across the measuring cup 10 at a constant velocity while emitting and/or omitting pulses.

The laser beam 228 may subsequently sweep across the measuring cup 10 along a second row of the grid (such as a row adjacent to the first row) while emitting pulses. The laser beam 228 may sweep across the first and second rows in the same direction or in opposite directions. For example, the laser beam 228 may sweep across the first row from “left-to-right” and across the subsequent/adjacent row from “right-to-left”.

Frequency or Repetition Rate, measured in Hz, is the number of laser pulses a single laser can deliver in a second. For instance a 1 MHz laser delivers 1,000,000 pulses per second where a 100 kHz repetition rate laser delivers 100,000 pulses per second. This lever can be important for processing a particular laser job in a short period of time. The more pulses per unit time available correlates inversely to the cycle time within a given row for a particular job. Pulse Energy is the amount of energy a single laser pulse contains and is typically measured in μJ or mJ. Average power=pulse energy (J)*rep rate (Hz or 1/sec). Typically, pulse energy is in the range of 5 μJ to 2000 μJ (2 mJ), optionally in the range of 7 μJ-1000 μJ, and optionally 10 μJ-300 μJ. Peak power is equal to pulse energy divided by pulse duration, and can be less than 100 nanoseconds, less than 50 nanoseconds, less than 20 nanoseconds, less than 10 nanoseconds, or less than 1 nanosecond. Therefore, pulse energy and pulse duration are linearly related to peak power. Shorter pulse durations like nanosec, picosec and femtosec lasers allow for very higher peak power which aid in the ability to mark articles.

Those skilled in the art will appreciate that the laser energy must be absorbed by the material constituting the measuring cup 10 for the measuring cup 10 to be marked with a chemically or structurally modified portion.

The laser energy may be absorbed by the material, optionally thermoplastic material, constituting the measuring cup 10 or by a laser absorption additive incorporated in the material constituting the measuring cup 10. As such, the wavelength of the laser 220 must overlap with an absorption band in the spectrum of at least one of the materials, optionally thermoplastic material, or a laser absorption additive incorporated into the measuring cup 10. For example, pulse lasers utilizing 355 nm (UV) may be absorbed by TiO2 added to the article, 532 nm (Green) may be absorbed by precious metal nanoparticles like gold, silver and copper, and 9-12 μm (IR) may be absorbed by PET which may be the base material of the article. Other pairings of laser wavelengths with the material, optionally thermoplastic material, or laser absorption additives for the measuring cup 10 exist and are contemplated herein.

The measuring cup 10 can be marked with chemically or structurally modified bits by the process of foaming, carbonization, ablation, etching, reduction, oxidation, or chemical modification. The term foaming means a process whereby the laser beam melts and vaporizes a portion of material which creates gas bubbles that become trapped or partially trapped within the molten resin and reflect the light diffusely when cooled. Foaming will generally produce lighter markings in areas that the laser has marked, and this method can be used for dark colored or opaque materials and translucent materials. The term translucent as used herein means the material, layer, article, or portion of the article being measured has total luminous transmittance of greater than 0% and less than or equal to 90%. The term transparent as used herein means the material, layer, article, or portion of the article being measured has a total luminous transmittance from greater than 90% to 100%. Translucent and transparent materials are light pervious. The term opaque as used herein means the material, layer, article, or portion of the article being measured has total luminous transmittance of about 0%. The total luminous transmittance is measured in accordance with ASTM D1003.

The bits forming the dosing indicium 60 can comprise gas bubbles. The gas bubbles can be distributed in the bits in the material constituting the sidewall 40. During formation of the gas bubbles, some of the bubbles may erupt from the interior surface 50 of the sidewall 40 and result in the interior surface 50 of the sidewall 40 having a rough surface. The dosing indicium 60 can comprise more gas bubbles per unit area than portions of the sidewall 40 adjacent the dosing indicium 60.

Carbonization is a chemical modification process that produces strong dark contrasts on bright surfaces, and is commonly used on carbon-containing polymers or bio-polymers or natural materials such as such as leather and wood and pulp-based materials. When carbonizing a material, the laser heats up the surface (minimum 100° C.) emitting oxygen, hydrogen, or a combination decomposition products. Carbonizing generally leads to dark chemically modified bits having higher carbon content, that is elemental carbon content or higher ratio of carbon to hydrogen, versus the original material or adjacent unmodified constituent material, making it a good choice for lighter colored articles, while the contrast may be less apparent on darker materials.

The bits forming the dosing indicium 60 can have a higher carbon content than the sidewall 40 adjacent the dosing indicium 60. Such bits can be formed with a laser that carbonizes the portion of the sidewall 40, for example the interior surface 50 or the interior surface 50 and material underneath the interior surface 50, at which the laser is directed. Optionally, the sidewall 40 can comprise an absorption additive. The absorption additive within the bits can have a different oxidative state than the absorption additive within the sidewall 40 adjacent the dosing indicium 60. The oxidative state of the absorption additive can be higher or lower relative to the oxidative state of the absorption additive in the sidewall 40 adjacent the dosing indicium 60. Optionally, the bits forming the dosing indicium 60 can be ablated or etched relative to the sidewall adjacent the dosing indicium 60. The bits forming the dosing indicium 60 can project above or be recessed relative to adjacent unmarked portions of the laser marked substrate.

Reduction and oxidation chemical modification processes involve the laser energy changing the oxidation state of at least one of the article's components such as a laser absorption additive or opacifying pigment, resulting in a discoloration or color change that is viewed as a chemically modified bit. For instance, the energy imparted from a UV laser can promote the reduction of TiO₂ to form a titanium sub-oxide where the oxidation state of titanium has been reduced to less than +4 and whereby this reduction results in a color change from colorless to blue, dark blue to black.

There are additional methods of marking a measuring cup 10. For example, annealing is a laser process available for metals and other materials. The heat produced from the laser beam chemically modifies the constituent material below the surface of the constituent material by way of oxidation, which results in a change of color on the material surface.

Staining is another chemical modification process achievable as the result of the chemical reaction created on materials when the heat of a laser beam is applied to the constituent material. Variations in color shades will depend on the compositions of the materials being stained. For example, lighter colored plastic materials can often discolor during the laser etching process, resulting in dark marking from the soot particles produced.

Laser engraving is the process of removing material as the workpiece surface is melted and evaporated by the laser beam, which produces an impression in the surface being engraved. Laser engraving is a structural modification of the sidewall 40 and may also be a chemical modification of the sidewall 40.

Removing material, sometimes referred to as etching, is a process in which the laser beam removes the top-most surface of a substrate or coating that was previously applied to the article's substrate. A contrast is produced as a result of the different colors of top coat and substrate or different topography and texture of the etched region versus the adjacent region. Etching is a structural modification of the sidewall 40. Although there is no specific limitation on the maximum or minimum depth of an etch, etching depths are typically in the range of about 0.001 mm to about 2.0 mm, including any depth within the range, such as for example, 0.010 mm, 0.075 mm, 0.100 mm, 0.200 mm, 0.300 mm, 0.400 mm, 0.500 mm, 1.0 mm, 1.5 mm and others.

Bleaching or photobleaching (sometimes termed fading), which is a chemical modification, is the photochemical alteration of a chromophore (such as in a pigment or dye) or fluorophore molecule such that its inherent color is permanently lost and/or is unable to fluoresce. This is caused by cleaving of covalent bonds or non-specific reactions between the chromophore/fluorophore and surrounding molecules.

Spot-size in laser marking relates to the focused area where the laser beam contacts the article. Spot size is the diameter of a round spot, or the average of 2 to 4 diameters taken around and within an irregularly shaped spot so that the computed diameter corresponds approximately to a circle having an area approximately equal to the area of the spot. The spot size can be modified by focusing or de-focusing the laser beam, but the fluence (energy per unit area) within the spot decreases as the spot is de-focused. Theoretically, the minimum spot-size achievable with any laser is the wavelength of the laser itself. As a practical matter, the minimum spot size achievable with pulse lasers may be from about 7 mm to about 20 μm. The spot sizes can be in the range of from about 5 mm to about 300 mm, optionally 10 μm to about 150 μm, optionally from about 20 μm to about 100 μm, optionally from about 30 μm to about 80 μm, optionally from about 40 μm to about 60 μm. Another way to think about spot size in a marking context is the size of the paintbrush an artist is using to paint. If fine detail is desired, then smaller spots sizes may be used. If larger areas are to be marked large spot sizes may be used. However, laser marking mechanisms require a minimum fluence to achieve the desired mark so balancing pulse energy, pulse duration, pulse overlap and spot size may be important.

Further, there is a region around the laser-contact spot which may also be heated in the course of the marking, though little or no material may be marked. The heat-effected zone can still yield effects such as crystallization which can impact the appearance and/or performance of the target material. Short pulse lasers (nano-second) have some heat effected zone, although substantially less than micro-second pulsed or continuous wave (CW) type lasers, (e.g. CO2, longer pulse IR lasers, etc.). Pico and femto second lasers are often referred to as ultra-short pulse and have very little to no heat effected zone. This capability can be helpful to control the thermal effects of the marking.

Geometry of the bit spacing can also be a key contributor to the cycle time and fluence or energy per unit area provided to an article. For example, the spacing between bits may be such that the bits do not overlap at all and have 0% overlap. At 0% overlap, each individual laser pulse is responsible for the energy provided to a chemically or structurally modified bit of the measuring cup 10. If the laser does not have sufficient pulse energy or peak power to form the desired chemically or structurally modified bit, then the pulse spacing can be decreased by an amount such that the chemically or structurally modified bits overlap in either one or both the X and Y-directions. Overlapping the chemically or structurally modified bits includes providing more than one laser pulse to the area of the measuring cup 10 in which the chemically or structurally modified bits overlap which, provides higher fluence or energy per unit area to that portion of the article. Additionally, pulse spacing can be an important lever for cycle time. If a laser has a fixed repetition rate or pulse frequency, then to achieve the lowest process time the pulses need to be spread out as much as possible while still achieving the desired mark type and mark contrast.

Pulse duration is the length of time a pulse remains continuously above half its maximum value. The shorter the pulse, the higher the peak power can be created with a common average power. This is because average power=pulse energy (J)*rep rate (Hz or 1/sec). Peak power is equal to pulse energy divided by pulse duration. Therefore, when pulse duration gets significantly smaller, the resulting peak pulse power is significantly higher. This peak power enables improved carbonization, foaming, ablation, etching, oxidation, reduction, etc. on the targets being marked. Short and ultrashort (pico/femto) pulse lasers take advantage of this phenomenon to be able to mark parts and can drive marking mechanisms typically not found in longer pulse lasers.

As mentioned, the lasing apparatus 200 sweeps the laser beam 228 across the measuring cup 10 while the laser pulses are either emitted from the laser or no pulse is emitted. A marked location occurs when the laser 220 emits a pulse to a given location and no location is marked when the laser does not emit a pulse to a given location. The laser beam 228 may be swept across the measuring cup 10 at a constant velocity while the repetition rate of the laser is constant, so the spacing of the bits will be regular in the direction in which the laser beam is swept across the measuring cup 10 (i.e. the X-direction).

The laser beam 228 may be swept across the measuring cup 10 in subsequent rows. The laser beam may be swept from left-to-right or from right-to-left and may sweep in the same direction as it is moved from row to row or may be swept in alternating directions as it moves from row to row. A key contributor to reducing cycle time includes sweeping the laser beam 228 in alternating directions as it moves from row to row. The rows may be generally parallel to one another. The distance between adjacent rows is the Y-distance. The rows can be orthogonal to or substantially orthogonal to the longitudinal axis of the measuring cup 10. The rows can be parallel to or substantially parallel to the longitudinal axis of the measuring cup 10. The rows can be aligned at an angle relative to the longitudinal axis of the measuring cup 10.

The locations in adjacent rows may lie directly above/below one another or may be offset relative to one another. If the offset is too great, the image produced by the laser marking (i.e. an icon or alphanumeric character) may appear blurred and may be illegible to the consumer or to a machine.

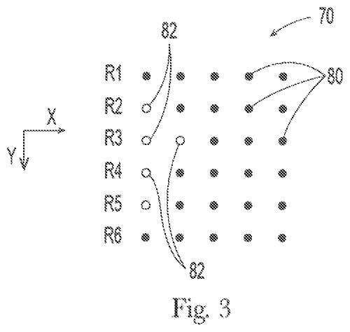

A bitmapped pattern is illustrated in FIG. 3. The bitmapped pattern can comprise at least two rows R (R1, R2, R3, . . . Rn) of bits. The bits 80/potential locations 82 within a row R can be irregularly spaced apart from one another or regularly spaced apart from one another. The bits 80/potential locations 82 amongst rows R can be irregularly spaced apart from one another or regularly spaced apart from one another. Optionally, the bits 80/potential locations 82 can be spaced apart from one another in a regular pattern within and amongst the rows R of bits. Optionally, the bits 80/potential locations 82 amongst the rows can be in registration with one another.

In FIG. 3, the bitmapped pattern 70 is a square pattern of chemically or structurally modified bits 80/potential locations 82. For reference, potential locations 82 that could be marked are illustrated as empty circles. The bitmapped pattern 70 in FIG. 3 has six rows R of bits 80/potential locations 82 illustrated as R1 to R6 in the Y-direction. Within each individual row R of the bitmapped pattern 70 of FIG. 3, adjacent bits 80/potential locations 82 are spaced apart from one another in a regular pattern. That is, adjacent bits 80/potential locations 82 in a row R are spaced apart from one another by the same distance.

In FIG. 3, the rows R of bits 80/potential locations 82 illustrated as R1 to R6 are in registration with one another and the bits 80/potential locations 82 are spaced apart from one another in a regular pattern amongst rows R. That is, the bits 80/potential locations 82 are substantially in line with one another in the Y-direction. In FIG. 3, the spacing between adjacent bits 80/potential locations 82 within a row R is the same as the spacing between adjacent rows R. Such bitmapped pattern 70 is a square bitmapped pattern 70. Optionally, rows R of the bitmapped pattern 70 may be spaced apart from one another in the Y-direction by a distance greater than the spacing amongst adjacent bits 80/potential locations 82 within a single row R. The bitmapped pattern 70 can be a rectangular bitmapped pattern 70 in which the rows of bits 80/potential locations 82 are spaced apart by a distance greater than the spacing between adjacent bits 80/potential locations 82 with a single row of bits 80/potential locations 82. When rows R of bits 80/potential locations 82 are in registration with one another and the bits 80/potential locations 82 are spaced apart from one another in a regular pattern amongst rows R, the bitmapped pattern can be a square or rectangular bitmapped pattern 70.

Optionally, the bits 80/potential locations 82 amongst rows R can be in registration within one another and the spacing between adjacent rows R can vary. For example, the spacing between pairs of rows, for example R1:R2, R2:R3, R3:R4, et cetera, can differ from one another or differ from adjacent pairs of rows R.

Optionally, the bits 80/potential locations 82 within rows R of the bitmapped pattern 70 may be nonuniformly spaced. Within a row R of bits 80/potential locations 82, the spacing between adjacent bits 80/potential locations 82 in the row R may differ from one another. One or more rows R of bits 80/potential locations 82 may be in registration with one another. Optionally, each row R may have nonuniformly spaced bits 80/potential locations 82 and the spacing of bits 80/potential locations 82 within each row R can differ from the spacing of bits 80/potential locations 82 in adjacent rows R. Such an arrangement can result in there being no consistent spatial relationship between bits 80/potential locations 82 with a single row R or amongst rows R.

The bits 80/potential locations 82 can be spaced apart from one another in an irregular pattern amongst rows R. The spacing of bits 80/potential locations 82 amongst rows R can be smaller in portions of the dosing indicium requiring greater resolution than in portions that do not require such a high resolution.

Bits 80/potential locations 82 constituting each of the rows R can be center to center spaced apart from one another by a first spacing and the rows can spaced apart from one another by a second spacing. The second spacing can differ from the first spacing. The second spacing can be greater than, equal to, or less than the first spacing. Without being bound by theory, it is thought that that the spacing between rows R can be greater than the spacing amongst bits 80/potential locations 82 within a row and still produce well defined dosing indicia 60 and such dosing indicia 60 can be marked at a higher speed than dosing indicia 60 having rows R that are spaced apart by the same distance as the spacing amongst bits 80/potential locations 82 within a row R. The spacing between rows R can be greater than or less than the spacing amongst bits 80/potential locations 82 within rows R.

A bitmapped pattern 70 can provide an advantage over a vector generated dosing indicium 60 in that for the same or similar desired overall visual impression for the dosing indicium 60, a bitmapped pattern 70 can often be marked faster on the measuring cup 10 than a vector generated dosing indicium 60, which ultimately reduces the cost of production of the measuring cup 10. Furthermore, at a given production rate per measuring cup 10, a larger bitmapped pattern 70 can be provided than would otherwise be markable using a vector process. A larger bitmapped pattern 70 corresponds to a larger dosing indicium 60, which can be easier to use than a smaller dosing indicium 60 that might be providable using a vector process. High speed marking of measuring cups 10 using vector processes tends to be limited to marking thin lines that are substantially parallel to the resting plane 120 and may only include numbers being in a small font size (e.g. 14 point or less), which may be difficult for the user to see.

Vector processes tend to be slow because of the multiple fixed short start and stop points that require the galvo sets to spend the majority of the time accelerating to the user set maximum velocity which is determined by the pulse spacing multiplied by the repetition rate and the length of the vector distance. Lengthy vector distances allow the vector lasing apparatus to reach its maximum velocity, while shorter vector distances has the lasing apparatus constantly accelerating and decelerating and never reaching maximum velocity resulting in longer marking times.

The vector process is less accurate than the bitmap process at high speeds, due to the acceleration/de-acceleration of the galvo sets steering the laser beam. Specifically, the location of each laser mark must be communicated from a computer driven software to the laser marking apparatus and such communication must be updated during the marking of the dosing indicium 60, for example, as the laser beam traverses a given row. Typical update frequencies for this communication are about 10 μs, so a laser outputting pulses with a repetition rate of 100 kHz would allow for an update in the communication for each individual laser pulse/mark. As the velocity of the laser beam across the surface of the article increases, repetition rates of greater than 100 kHz are required to achieve the desired spacing amongst bits 80 within the rows, and each update from the software must now communicate the location of multiple marked bits 80 (or potential locations 82). While the calculations can be performed nearly instantaneously, in the extremely fast time-domains of high-speed laser marking, the galvos cannot respond as quickly, and the accelerate/de-accelerate profile of the vector process results in a significant number of misplaced marked bits 80 within a given row R.

For a given area of dosing indicium 60 that is more than a straight line, a bitmapped pattern 70 can be produced more quickly than a vector marked dosing indicium 60. From a practical perspective, given the production speed limitations of vector processes, using a bitmapped pattern 70 can enable a larger dosing indicium 60 to be produced than could be produced using a vector process in a reasonable amount of time. A bitmapped pattern 70 constituting a dosing indicium 60 that is a continuous region present on more than about 0.5% of the interior surface 50 of the sidewall 40 can be practical to mark at high speed, meaning that a high production rate of marked measuring cups 10 is possible. The dosing indicum 60 can be a continuous region present on more than about 0.5%, optionally more than about 0.75%, optionally more than about 1%, optionally more than about 1.25%, optionally more than about 1.5% of the interior surface, optionally more than about 3% of the interior surface, optionally more than about 5% of the interior surface. The measuring cup 10 can comprise more than one dosing indicium 60 and the dosing indicia 60 combined can be present on more than about 3%, optionally more than about 3.5%, optionally on more than about 4%, optionally on more than about 5% of the interior surface 50, optionally more than about 8% of the interior surface 50. A larger dosing indicium 60 can be easier for the user to use to measure the amount of product dispensed into the measuring cup.

Aspects of high speed laser marking on articles and high speed laser making processes for marking articles are disclosed in U.S. patent application Ser. Nos. 17/963,214, 17/963,215, 17/987,893, 17/987,895, 18/127,965 and 18/127,976.

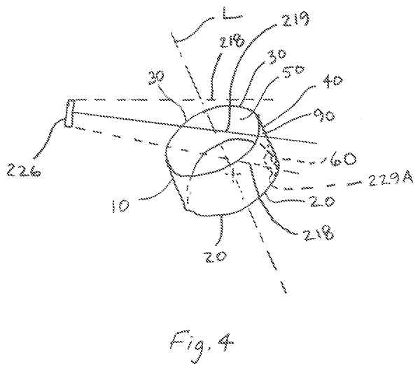

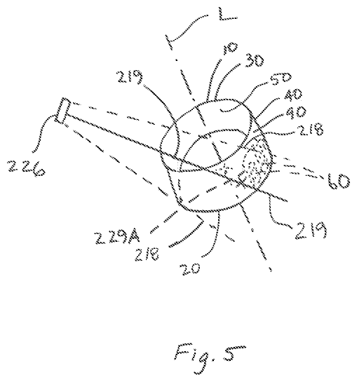

The measuring cup 10 can be positioned at least partially within the field of view 218 such that a first worked portion (229A) of the sidewall 40 is oriented towards the lens 226, within the field of view 218 of the lens 226, spaced apart from the optical axis 219, and the optical axis 219 is oblique, as in FIG. 4, or askew of the longitudinal axis L. The optical axis 219 can be oblique to the longitudinal axis L, as illustrated in FIG. 4, or askew of the longitudinal axis L. In FIG. 4, the optical axis 219 is oblique to the longitudinal axis in that the optical axis 219 intersects the longitudinal axis L. As used herein, oblique means intersecting and not perpendicular. In FIG. 4, the optical axis 219 intersects the longitudinal axis L at a non-perpendicular angle. In FIG. 5, the optical axis 219 is askew of the longitudinal axis L. As used herein, askew means not intersecting and not parallel. In FIG. 5, the optical axis 219 does not intersect the longitudinal axis L.

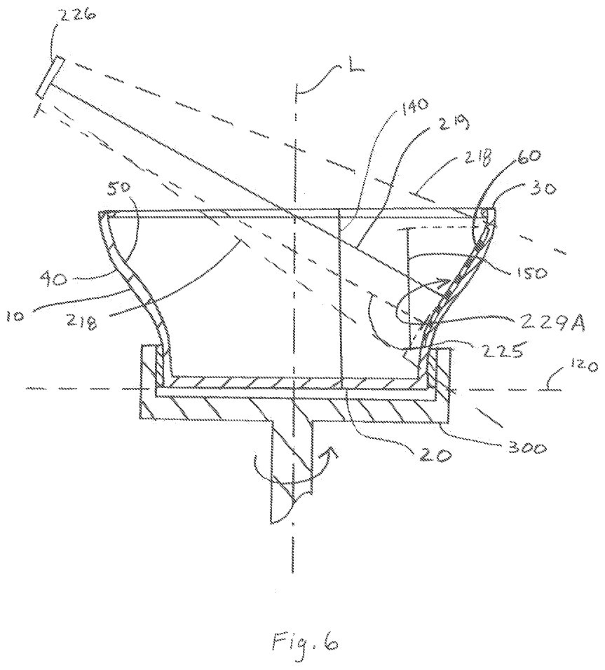

A cross section of a measuring cup 10 is shown in FIG. 6. As shown in FIG. 6, the first worked portion 229A can be in the interior surface 50. The sidewall 40 can have a sidewall height 140 between the resting plane 120 and the open end 30. The sidewall height 140 is measured orthogonal to the resting plane 120. The sidewall height 140 is a scalar quantity. Likewise, the dosing indicium 60 can have a dosing indicium height 150 measured of a maximum extent of the dosing indicium 60 orthogonal to the resting plane 120. The dosing indicium height 150 can be from about 20% to about 100% of the sidewall height 140 measured at the dosing indicum 60. A dosing indicium 60 having such a height relative to the sidewall height 140 can be easy for the user to identify on the interior surface 50 of the measuring cup 10. Positioning the measuring cup 10 relative to the lasing apparatus 200 such that the optical axis 219 is oblique or askew of the longitudinal axis L can be advantageous for laser marking the interior surface 50 of the measuring cup 10.

The first worked portion 229A of the sidewall 40, in particular the interior surface 50 thereof, can be positioned so that the first worked portion 229A is approximately orthogonal to the optical axis 219. The first worked portion 229A can be curved or slightly curved so that in reality the first worked portion 229A is positioned to be relatively flatly facing the lens 226 in a practical sense since the entirety of a curved first worked portion 229A cannot be orthogonal to the optical axis 219. Such arrangements can provide for the first worked portion 229A being spaced apart from the lens 226 by approximately the working distance 225. The spot of the laser is focused at the working distance 225 and the focus decreases as a function of distance away from the working distance 225, towards and away from the lens 226. The first worked portion 229A of the sidewall may be flat or have an irregular shape. For a flat first worked portion 229A, the measuring cup 10 can be positioned such that the first worked portion 229A is orthogonal to the optical axis 219. For a curved first worked portion 229A, the measuring cup 10 can be positioned such that at least some part of the first worked portion 229A is orthogonal to the optical axis 219. Optionally, the first worked portion 229A of the sidewall 40 can be spaced apart from the optical axis 219. The first worked portion 229A can be positioned such that more than about 20% by area, optionally more than about 50% by area, optionally more than about 80% by area, optionally the entirety of the first worked portion 229A is within plus or minus 10%, optionally plus or minus 5%, optionally plus or minus 3.5% of the working distance 225.

The measuring cup 10 can held by a spindle 300 engaged with one or both of the exterior surface 90 and bottom end 20 and the dosing indicium 60 can be provided on the interior surface 50 and optionally the bottom end 20. Optionally, the measuring cup 10 can be held by a spindle engaged with one or both of the interior surface 50 and bottom end 20 and the dosing indicium 60 can be provided on the exterior surface 90. The spindle can be mechanically driven to rotate, for example by a motor or linkage system, and thereby rotate the measuring cup 10 about the longitudinal axis L.

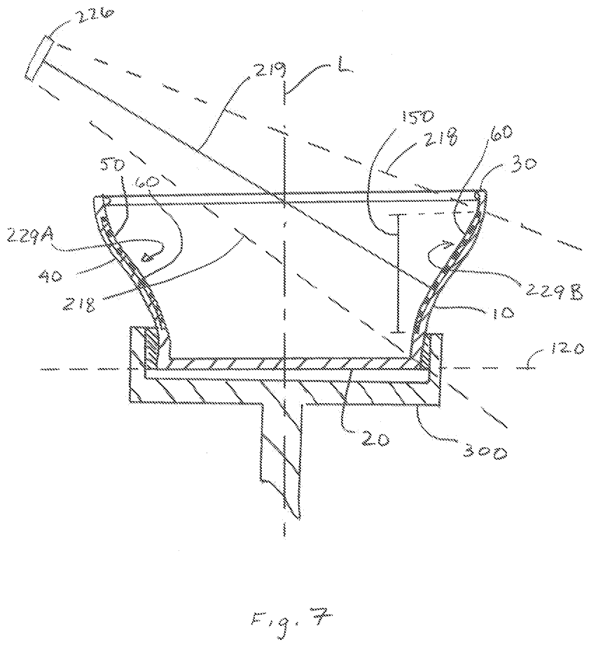

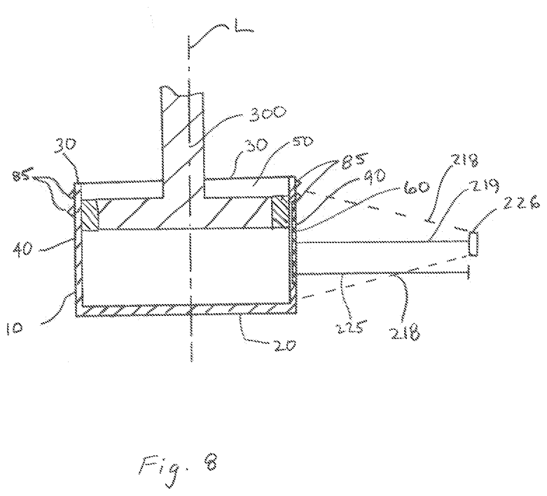

An individual lasing apparatus 200 can be used to lase the first worked portion 229A and a second worked portion 229B (FIG. 7). After lasing the first worked portion 229A, the measuring cup 10 can be repositioned, for example by rotating the measuring cup 10 about its longitudinal axis L or repositing the measuring cup 10 otherwise, so that a second worked portion 229B of the sidewall 40 is oriented towards the lens 226. Optionally, the second worked portion 229B of the sidewall 40 can be spaced apart from the optical axis 219. A dosing indicium 60 can be lased into the sidewall 40 at the second worked portion 229B. The first worked portion 229A and the second worked portion 229B can be in the interior surface 50. Optionally, the first worked portion 229A, and optional second worked portion 229B, can be in the exterior surface 90 so that the dosing indicium 60 is in the exterior surface 90 of the measuring cup 10, by way of nonlimiting example as shown in FIG. 8. The first worked portion 229A and the second worked portion 229B can be in the exterior surface 90.

The measuring cup 10 can have threads 85 in the exterior surface 90 or interior surface 50. A measuring cup 10 configured to have threads 85 can be the closure of a container. The measuring cup 10 can be threadingly engaged with the open end of a container. To use the measuring cup 10, a user unscrews the measuring cup 10 from container and holds or places the measuring cup 10 upright so that the contents of the container can be dispensed into the measuring cup 10. The threads 85 can be on the interior surface 50 or on the exterior surface 90. Optionally the measuring cup 10 can be removably engaged with a container via a tongue and groove fitting. Optionally, the threads 85 can be on an inner collar, for example an inner collar around the longitudinal axis L, extending from the bottom end 20 towards the open end 30. Threads 85 on an inner collar can be oriented towards the longitudinal axis L or oriented away from the longitudinal axis L. The inner collar can be positioned between the sidewall 40 and the longitudinal axis L.

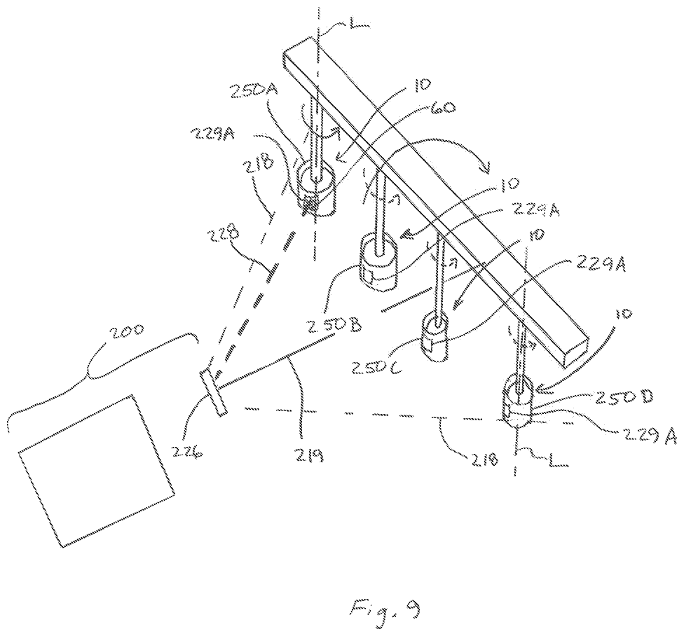

A plurality of measuring cups 10 can be provided with the field of view 218 of the lasing apparatus 200, by way of nonlimiting example as shown in FIG. 9. An individual lasing apparatus 200 can be able to be targeted upon two or more measuring cups 10. In operation, the dosing indicum 60 can be lased into the first worked portion 229A of a first member 250A of the plurality. Then the lasing apparatus 200 can lase a dosing indicium 60 into the first worked portion 229A of a second member 250B of the plurality. Optionally, the lasing apparatus 200 can lase a dosing indicium 60 into the first worked portion 229A of a third member 250C and optionally a fourth member 250D of the plurality. The number of members in the plurality can be any number so long as that number of measuring cups 10 can be targeted by a single lasing apparatus 200. For a fixed lens 226, the first worked portions 229A need to be positioned or able to be positioned within the field of view 218 of the lasing apparatus 200 working thereon.

Lasing a plurality of measuring cups 10 with a single lasing apparatus 200 can provide for productivity benefits. The rate limiting process in producing lased measuring cups 10 can be the step of properly positioning the measuring cup 10 in front of the lasing apparatus 200. Gathering multiple measuring cups 10 to assemble a mast of a plurality of measuring cups 10 upon which a single lasing apparatus 200 can work can improve productivity because the step of lasing the dosing indicium 60 into an individual measuring cup 10 can be faster than the rate for properly positioning an individual measuring cup 10. In operation, when the plurality of measuring cups 10 is properly positioned, the lasing apparatus 200 can work on the first worked portion 229A of the first member 250A and then subsequently work the first worked portion 229A of the second member 250B followed serially by additional members of the plurality of measuring cups 10. After the dosing indicum 60 is lased into each of the members of the plurality of measuring cups 10, the measuring cups 10 can be moved together downstream of the lasing apparatus 200.

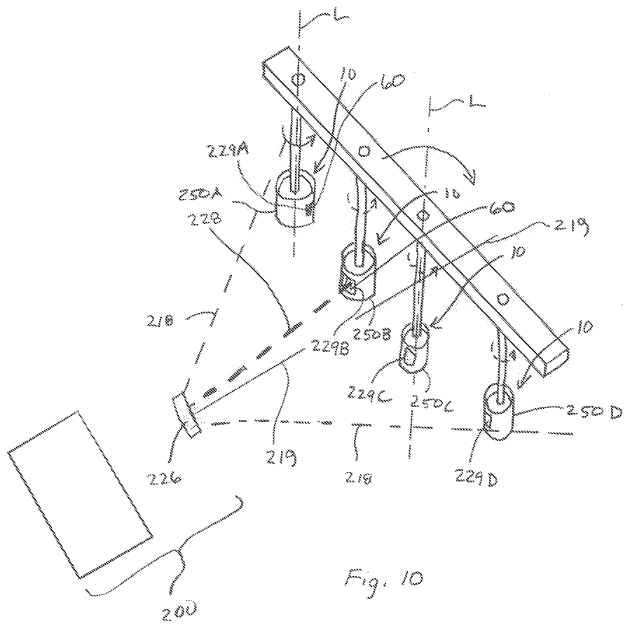

If multiple dosing indicia 60 are to be in an individual measuring cup 10, it can be practical to lase the dosing indicium 60 into the first worked portion 229A of the first member 250A of the plurality of measuring cups 10, the heavy dashed line in FIG. 9 being the laser beam 228, and then lase the dosing indicium 60 into the second member 250B of the plurality. The first member 250A of the plurality can be rotated about the longitudinal axis L such that the second worked portion 229B of the sidewall 40 of the first member 250A is oriented towards the lens 226 and optionally spaced apart from the optical axis 219. This can occur before, after, or while the dosing indicium 60 is being lased into the second member 250B of the plurality. Then the dosing indicium 60 can be lased into the second worked portion 229B of the first member 250A before, after, or while rotating the second member 250B of the plurality about the longitudinal axis L such that the second worked portion 229B of the second member 250B is oriented towards the lens 226 and optionally spaced apart from the optical axis 219. Then the dosing indicium 60 can be lased into the second worked portion 229B of the second member 250B. For example, as illustrated in FIG. 10, the dosing indicum 60 in the first worked portion 229A of the first member 250A has already been lased. While the first member 250A is being rotated to orient the second worked area 229A towards the lens 226, the first worked portion 229A of the second member 250B is being lased, the heavy dashed line in FIG. 10 being the laser beam. The principle of using a single lasing apparatus 200 to mark multiple worked portions of multiple measuring cups 10 is that while one worked portion on one measuring cup 10 is being lased, another of the measuring cups 10 can be in the process of being repositioned so that another worked portion of that measuring cup 10 will be in proper position to be lased. This can reduce idle time of the lasing apparatus 200 since the repositioning step for one measuring cup 10 can be occurring while lasing is occurring on another measuring cup 10.

Optionally, the second worked portion 229B of the sidewall 40 of the first member 250A can be spaced apart from the longitudinal axis L. Such an arrangement might be practical for an even number of measuring cups 10 in the plurality of measuring cups 10. The optical axis 219 of the lens 226 may be sighted between, or even equidistant from, two measuring cups 10.

The first worked portion 229A of the sidewall 40 can be entirely spaced apart from the optical axis 219. Optionally, the second worked portion 229B of the sidewall 40 can be entirely spaced apart from the optical axis 219. Optionally the first worked portion 229A and second worked portion 229B can be entirely spaced apart from the optical axis 219. Placing one or both of the first worked portion 229A and second worked portion 229B as such can be practical if the interior surface 50 of the sidewall 40 is to be lased since a portion of the sidewall 40 opposite the worked portion can obstruct parts of the field of view 218 of the lasing apparatus 200. Such an arrangement can also if more than one measuring cup 10 is to be worked by a single lasing apparatus 200.

The dosing indicium 60 in the first worked portion 229A and second worked portion 229B of a single measuring cup 10 can be the same as one another or differ from one another. For example, the dosing indicium 60 in the first worked portion 229A may be in English and the dosing indicium 60 in the second worked portion 229B may be in French. Optionally, the dosing indicium 60 in the first worked portion 229A may be in a format that differs from the dosing indicium 60 in the second worked portion 229B. For example, one may be in the form of a bar and the other may in the form of a line.

Within the plurality of measuring cups 10 being worked, the dosing indicia 60 on the measuring cups 10 can be the same as one another or differ from one another. For example, the dosing indicium 60 on one measuring cup 10 can be in format that differs from the dosing indicium 60 on another measuring cup 10. For example, one may be alphanumeric and another in the form of a number of images of laundry baskets that are indicative of the mass of laundry being washed or a number of images of flowers that are indicative of the scent benefit that may be achieved by using different volumes of liquid or particulate composition.

The measuring cups 10 within the plurality of measuring cups 10 can be same as one another or differ from one another. For example the measuring cups 10 can differ from one another in size and or shape.

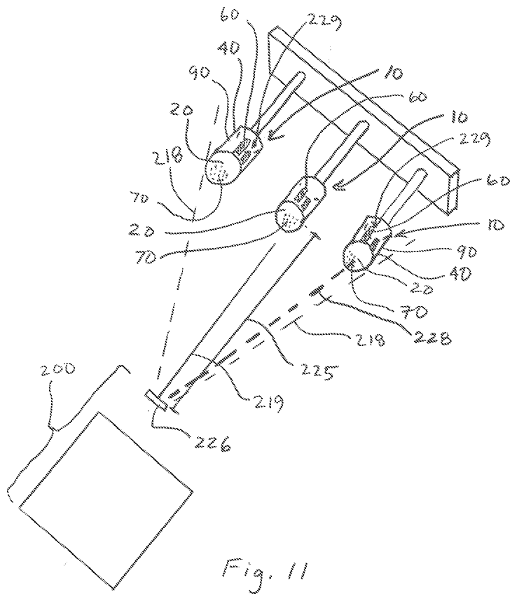

The measuring cups 10 can comprise two or more dosing indicia 60. The measuring cups 10 can comprise one or more dosing indicia 60 and comprising a laser marked portion or portions other than the dosing indicia 60. In addition to one or more dosing indicia 60 located in the sidewall of the measuring cups 10, a bitmapped pattern 70 can be lased into the bottom end 20 (FIG. 11). This can be achieved by repositioning the measuring cup 10 so that the bottom end 20 is presented to the lens 226, at least partially within the field of view 218, spaced apart from the lens 226 by the working distance 225, and lasing the bitmapped pattern 70 into the bottom end 20. Optionally, the bitmapped pattern 70 can be provided by a lasing apparatus 200 other than the lasing apparatus 200 that forms the dosing indicium 60 or dosing indicia 60 in the side wall, for example at a different lasing station. Providing a bitmapped pattern 70 in the bottom end 20 can be practical for providing information that is readily perceivable by the user of the measuring cup 10 as the user attempts to remove the measuring cup 10 from the container. The bottom end 20 can be lased in interior surface of the bottom end 20 or in the exterior surface of the bottom end 20. The interior surface of the bottom end 20 can be oriented towards the lens 226 or the exterior surface of the bottom end 20 can be oriented towards the lens 226.

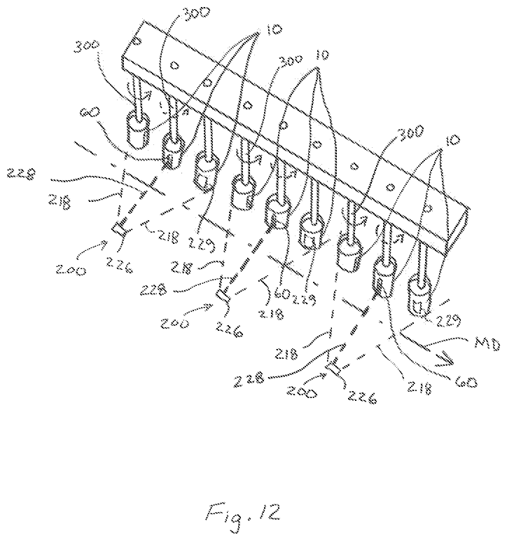

A plurality of lasing apparatuses 200 can be provided and positioned along a machine direction MD (FIG. 12). Individual lasing apparatuses 200 can be uniquely associated with one unique plurality of measuring cups 10. The plurality of measuring cups 10 can be lased as described above in that a single lasing apparatus 200 is used to lase a plurality of dosing cups 10 positioned within the field of view 218 of the single lasing apparatus 200 in one or more worked portions on each dosing cup 10.

The step of lasing the dosing indicium 60 can be fast relative to other steps in the process. Positioning a measuring cup 10 properly in the field of view 218 of a lasing apparatus 200 can be slow relative to the step of lasing the dosing indicium 60 into the measuring cup 10. As such, it can be more productive to position a mast of multiple dosing cups 10 to be laser marked in front of one or more lasing apparatuses 200 and use one lasing apparatuses 200 to simultaneously lase two or more measuring cups 10 and potentially use multiple lasing apparatuses 200 simultaneously on unique pluralities of measuring cups 10, the pluralities of measuring cups 10 constituting a mast of dosing cups. And there is a potential productivity gain to be achieved by using a single lasing apparatus 200 to laser mark a plurality of measuring cups 10.

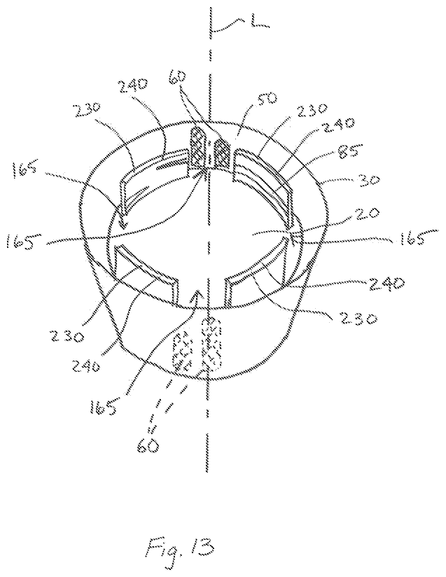

The measuring cup 10 can further comprise an inner collar 230 projecting from said bottom end 20 such that the inner collar 230 is between the sidewall 40 and the longitudinal axis L (FIG. 13). The inner collar 230 can be positioned between the sidewall 40 and the longitudinal axis L. The inner collar 230 can extend around the longitudinal axis L continuously or partially. The inner collar 230 can comprise threads 85 or lugs oriented towards the longitudinal axis L. The inner collar 230 can comprise threads 85 or lugs oriented away from the longitudinal axis L. The threads 85 or lugs can mechanically engage with a corresponding threads or lugs on the neck of the container. The inner collar 230 can extend from the bottom end 20 to the collar rim 240. The collar rim 240 can comprise one or more slots 165. The slot 165 or slots 165 can extend partially into the inner collar 230. Optionally the slots 165 can extend to the bottom end 20 such that the inner collar 230 is discontinuous about the longitudinal axis L.

The inner collar 230 can comprise one or more slots 165 in the inner collar 230 or between sections of the inner collar 230. At least one dosing indicium 60 can be registered with at least one of the slots 165 relative to the longitudinal axis L. Optionally, the inner collar 230 can comprise a pair of slots 165 at radially opposite positions about the longitudinal axis L. The measuring cup 10 can comprise two dosing indicia 60 positioned at the radially opposite positions.

The inner collar 230 can comprise one slot 165. Optionally, the inner collar 230 can comprise two slots 165, optionally with the two slots positioned at radially opposite positions about the longitudinal axis L. The inner collar 230 can comprise three, four, or more slots 165 positioned around the longitudinal axis L. A dosing indicium 60 can be integral with the interior surface 50 of the sidewall 40 and each dosing indicium 60 can be in registration with a slot 165 in the inner collar 230.

For measuring cups 10 comprising an inner collar 230, in absence of a slot 165, it can be difficult to laser mark the interior surface 50 since the laser beam 228 will need to approach the interior surface 50 at a steep angle. That can result in different portions of the interior surface 50 being at different distances from the laser 220 and the spot size of the laser 220 may vary. A variable spot size results in a variable amount of fluence delivered to different portions of the interior surface 50, which can result in undesirable variability in the chemical or structural modification of individual bits 80 of the bitmapped pattern 70. Providing slots in the inner collar 230 can help the manufacturer reduce the angle of incidence of the laser beam 228 as applied to the interior surface 50 of the sidewall 40, which can improve the uniformity of the marked bits 80. The greater the uniformity of the marked bits 80, the greater the uniformity of the visual impression of the dosing indicium 60. In essence, the laser beam 228 is aimed through the slot 165. In absence of the slots 165 in the inner collar 230, the spot size of the laser beam 228 on the interior surface 50 could excessively vary as a function of position along the longitudinal axis L. Moreover, the slots 165 in the inner collar 230 can also enable the manufacturer to direct the laser beam 228 to portions of the interior surface 50 of the sidewall 40 nearer to the bottom end 20, without excessive variation in the spot size of the laser beam 228 acting on the interior surface 50. For example, at least part of the dosing indicium 60 can be located at a position measured from the resting plane 120 that is less than about 25% of the sidewall height 140. A dosing indicium 60 positioned near the bottom end 20 can be useful for helping the user measure small quantities of the product being measured with the measuring cup 10.

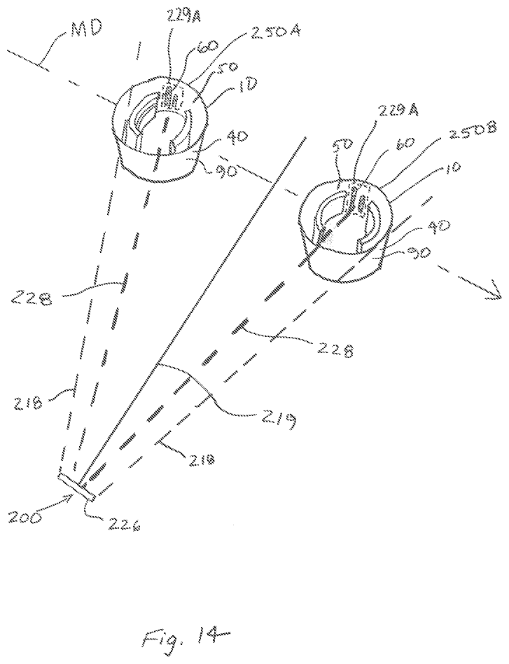

A plurality of measuring cups 10 can be provided within the field of view 218 of the lasing apparatus 200 such that the interior surfaces 50 thereof are oriented towards a lens 226, by way of nonlimiting example as shown in FIG. 14. In such an arrangement, the interior surfaces 50 thereof can be provided with one or more dosing indicia 60. An individual lasing apparatus 200 can be able to be targeted upon two or more measuring cups 10. In operation, the dosing indicum 60 can be lased into the first worked portion 229A of a first member 250A of the plurality. Then the lasing apparatus 200 can lase a dosing indicium 60 into the first worked portion 229A of a second member 250B of the plurality. Optionally, the lasing apparatus 200 can lase a dosing indicium 60 into the first worked portion 229A of a third member and optionally a fourth member the plurality. The number of members in the plurality can be any number so long as that number of measuring cups 10 can be targeted by a single lasing apparatus The interior surfaces 50 can be provided with one or more dosing indicia 60 in the same manner as discussed previously with the difference being that the interior surfaces 50 are oriented towards a lens 226 rather than the exterior surfaces 90.

The interior surfaces 50 of multiple measuring cups 10 can be marked as described and illustrated previously. After the dosing indicia 60 is lased into the first worked portion 229A of the first member 250A, the laser 200 can be targeted on the first worked portion 229A of a second member 250B and the dosing indicia 60 can be lased therein. Before, during, or after the dosing indicia 60 is lased into the second member 250B, the first member 250A can be rotated to present a second worked portion 229B towards the lens 226 and a dosing indicia 60 can be lased in the second worked portion 229B of the first member 250A. Before, during, or after the dosing indica 60 is lased into the second worked portion 229B of the first member 250A, the second member 250B can be rotated to present a second worked portion 229B of the second member 250B towards the lens 226 and a dosing indicia 60 can be lased into the second worked portion 229B of the second member 250B.

### Combinations

An Example follows:

A. A process for laser marking a measuring cup (10) comprising steps of:
providing a measuring cup comprising:
   a bottom end (20), an open end (30) opposite said bottom end, and a longitudinal axis (L) passing through said bottom end, wherein said bottom end defines a resting plane (120); and
   a sidewall (40) extending about said longitudinal axis from said bottom end to said open end;
providing a lasing apparatus (200) comprising a lens (226) having an optical axis (219), a working distance (225), and a field of view (218);
positioning said measuring cup at least partially within said field of view such that a first worked portion (229A) of said sidewall is oriented towards said lens, within said field of view, spaced apart from said lens by said working distance, and is spaced apart from said optical axis, and said optical axis is oblique or askew of said longitudinal axis; and
lasing a dosing indicium (60) into said first worked portion.

B. The process according to Claim A, wherein said sidewall has a sidewall height (140) between said resting plane and said open end, wherein said sidewall height is measured orthogonal to said resting plane, wherein said dosing indicium has a dosing indicium height (150) measured over a maximum extent of said dosing indicium orthogonal to said resting plane, wherein said dosing indicium height is from about 20% to about 100% of said sidewall height measured at said dosing indicium.

C. The process according to Paragraph A or B, wherein said dosing indicium extends over said first worked portion of said sidewall, wherein said lasing apparatus has a working distance, and wherein said first worked portion is within plus or minus 10%, optionally plus or minus 5%, optionally plus or minus 3.5% of said working distance.

D. The process according to any of Paragraphs A to C, wherein said optical axis is oblique to said longitudinal axis.

E. The process according to any of Paragraphs A to C, wherein said optical axis is askew of said longitudinal axis.

F. The process according to any of Paragraphs A to E further comprising steps of:
rotating said measuring cup about said longitudinal axis such that a second worked portion (229B) of said sidewall is oriented towards said lens and is spaced apart from said optical axis; and
lasing said dosing indicium into said sidewall.

G. The process according to any of Paragraphs A to F, wherein said sidewall has an exterior surface (90) oriented away from said longitudinal axis and said first worked portion is in said exterior surface.

H. The process according to any of Paragraph A to F, wherein said sidewall has an interior surface (50) oriented towards said longitudinal axis and said first worked portion is in said interior surface.

I. The process according to Paragraph H, wherein said measuring cup further comprises an inner collar projecting from said bottom end such that said inner collar is between said sidewall and said longitudinal axis;
wherein said inner collar comprises one or more slots in said inner collar or between sections of said inner collar; and
wherein at least one said dosing indicia is registered with at least one said slot relative to said longitudinal axis.

J. The process according to any of Paragraphs A to I, wherein said first worked portion of said sidewall is entirely spaced apart from said optical axis.

K. The process according to any of Paragraphs A to J further comprising steps of:
repositioning said measuring cup so that said bottom end is presented to said lens, at least partially within said field of view, spaced apart from said lens by said working distance; and lasing a bitmapped pattern (70) into said bottom end.

L. The process according to any of Paragraphs A to F, further comprising steps of: providing a plurality of said measuring cups within said field of view of said lasing apparatus;
lasing said dosing indicium into said first worked portion of a first member (250A) of said plurality;
lasing said dosing indicium into a second member (250B) of said plurality;
rotating said first member of said plurality about said longitudinal axis such that a second worked portion (229B) of said sidewall of said first member is oriented towards said lens; lasing said dosing indicium into said second worked portion of said first member;
rotating said second member of said plurality about said longitudinal axis such that said second worked portion of said sidewall of said second member is oriented towards said lens; and
lasing said dosing indicium into said second worked portion of said of said second member.

M. The process according to Paragraph L, wherein said sidewall has an interior surface oriented towards said longitudinal axis and said first worked portion and said second worked portion are in said interior surface.

N. The process according to Paragraph L, wherein said sidewall has an exterior surface oriented away from said longitudinal axis and said first worked portion and said second worked portion are in said exterior surface.

O. The process according to any of Paragraphs L to N, wherein lasing said dosing indicium into said second member of said plurality is performed while rotating said first member of said plurality about said longitudinal axis such that said second worked portion of said sidewall of said first member is oriented towards said lens.

P. The process according to any of Paragraphs L to O, wherein lasing said dosing indicium into said second worked portion of said first member is performed while rotating said second member of said plurality about said longitudinal axis such that said second worked portion of said sidewall of said second member is oriented towards said lens;

Q. The process according to any of Paragraphs L to P, wherein said second worked portion of said sidewall of said first member is spaced apart from said optical axis.

R. The process according to any of Paragraphs L to Q, wherein said second worked portion of said sidewall of said second member is spaced apart from said optical axis.

S. The process according to any of Paragraphs L to R, further comprising steps of: providing a plurality of said lasing apparatuses positioned along a machine direction (MD), wherein individual said lasing apparatuses are uniquely associated with one unique said plurality of measuring cups.

T. The process according to Paragraph S, wherein said lasing apparatuses lase simultaneously.

U. The process according to any of Paragraphs A to K, further comprising the steps of: providing a plurality of said measuring cups and lasing apparatuses positioned along a machine direction, wherein individual said lasing apparatuses are uniquely associated with one said measuring cup.

V. The process according to any of Paragraphs A to K, further comprising the steps of: providing a plurality of said measuring cups within said field of view of said lasing apparatus;
lasing said dosing indicium into said sidewall of a first member of said plurality followed by
lasing said dosing indicium into said sidewall of a second member of said plurality.

W. The process according to Paragraphs A to K further comprising the steps of:
providing a plurality of said measuring cups and lasing apparatuses positioned along a machine direction, wherein a plurality of measuring cups are within said field of view of a single said lasing apparatus.

X. The process according to any of Paragraphs A to W further comprising steps of:
repositioning said measuring cup so that said bottom end is presented to said lens, at least partially within said field of view, spaced apart from said lens by said working distance; and lasing a bitmapped pattern into said bottom end.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. U.S. patent application Ser. Nos. 17/963,214, 17/963,215, 17/987,893, 17/987,895, 18/127,965, and 18/127,976 are hereby incorporated by reference in their entirety. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for laser marking a measuring cup comprising steps of:
providing a measuring cup comprising:
a bottom end, an open end opposite said bottom end, and a longitudinal axis passing through said bottom end, wherein said bottom end defines a resting plane; and
a sidewall extending about said longitudinal axis from said bottom end to said open end;
providing a lasing apparatus comprising a lens having an optical axis, a working distance, and a field of view;
positioning said measuring cup at least partially within said field of view such that a first worked portion of said sidewall is oriented towards said lens, within said field of view, spaced apart from said lens by said working distance, and is spaced apart from said optical axis, and said optical axis is oblique or askew of said longitudinal axis; and
lasing a dosing indicium into said first worked portion.

2. The process according to claim 1, wherein said sidewall has a sidewall height between said resting plane and said open end, wherein said sidewall height is measured orthogonal to said resting plane, wherein said dosing indicium has a dosing indicium height measured over a maximum extent of said dosing indicium orthogonal to said resting plane, wherein said dosing indicium height is from about 20% to about 100% of said sidewall height measured at said dosing indicium.

3. The process according to claim 1, wherein said dosing indicium extends over said first worked portion of said sidewall, wherein said lasing apparatus has a working distance, and wherein said first worked portion is within plus or minus 10%, optionally plus or minus 5%, optionally plus or minus 3.5% of said working distance.

4. The process according to claim 1, wherein said optical axis is oblique to said longitudinal axis.

5. The process according to claim 1, wherein said optical axis is askew of said longitudinal axis.

6. The process according to claim 1 further comprising steps of:
rotating said measuring cup about said longitudinal axis such that a second worked portion of said sidewall is oriented towards said lens and is spaced apart from said optical axis; and
lasing said dosing indicium into said sidewall.

7. The process according to claim 1, wherein said sidewall has an exterior surface oriented away from said longitudinal axis and said first worked portion is in said exterior surface.

8. The process according to claim 1, wherein said sidewall has an interior surface oriented towards said longitudinal axis and said first worked portion is in said interior surface.

9. The process according to claim 8, wherein said measuring cup further comprises an inner collar projecting from said bottom end such that said inner collar is between said sidewall and said longitudinal axis;
wherein said inner collar comprises one or more slots in said inner collar or between sections of said inner collar; and
wherein at least one said dosing indicia is registered with at least one said slot relative to said longitudinal axis.

10. The process according to claim 1, wherein said first worked portion of said sidewall is entirely spaced apart from said optical axis.

11. The process according to claim 1 further comprising steps of:
repositioning said measuring cup so that said bottom end is presented to said lens, at least partially within said field of view, spaced apart from said lens by said working distance; and
lasing a bitmapped pattern into said bottom end.

12. The process according to claim 1, further comprising steps of:
providing a plurality of said measuring cups within said field of view of said lasing apparatus;
lasing said dosing indicium into said first worked portion of a first member of said plurality;
lasing said dosing indicium into a second member of said plurality;
rotating said first member of said plurality about said longitudinal axis such that a second worked portion of said sidewall of said first member is oriented towards said lens;
lasing said dosing indicium into said second worked portion of said first member;
rotating said second member of said plurality about said longitudinal axis such that said second worked portion of said sidewall of said second member is oriented towards said lens; and
lasing said dosing indicium into said second worked portion of said of said second member.

13. The process according to claim 12, wherein said sidewall has an interior surface oriented towards said longitudinal axis and said first worked portion and said second worked portion are in said interior surface.

14. The process according to claim 12, wherein said sidewall has an exterior surface oriented away from said longitudinal axis and said first worked portion and said second worked portion are in said exterior surface.

15. The process according to claim 12, wherein lasing said dosing indicium into said second member of said plurality is performed while rotating said first member of said plurality about said longitudinal axis such that said second worked portion of said sidewall of said first member is oriented towards said lens.

16. The process according to claim 12, wherein lasing said dosing indicium into said second worked portion of said first member is performed while rotating said second member of said plurality about said longitudinal axis such that said second worked portion of said sidewall of said second member is oriented towards said lens.

17. The process according to claim 12, wherein said second worked portion of said sidewall of said first member is spaced apart from said optical axis.

18. The process according to claim 12, wherein said second worked portion of said sidewall of said second member is spaced apart from said optical axis.

19. The process according to claim 12, further comprising steps of:
providing a plurality of said lasing apparatuses positioned along a machine direction, wherein individual said lasing apparatuses are uniquely associated with one unique said plurality of measuring cups.

20. The process according to claim 1, further comprising the steps of:
providing a plurality of said measuring cups within said field of view of said lasing apparatus;
lasing said dosing indicium into said sidewall of a first member of said plurality followed by
lasing said dosing indicium into said sidewall of a second member of said plurality.
